(19) United States
(12) Patent Application Publication
(10) Pub. No.: US 2013/0273198 A1
(43) Pub. Date: Oct. 17, 2013

(54) Preparation of Baked Product From Dough

(71) Applicants: Tina Salomonsen, Copenhagen (DK); Merete Moeller Engelsen, Frederiksberg (DK); Katja Salomon Johansen, Gentofte (DK)

(72) Inventors: Tina Salomonsen, Copenhagen (DK); Merete Moeller Engelsen, Frederiksberg (DK); Katja Salomon Johansen, Gentofte (DK)

(73) Assignee: Novozymes A/S, Bagsvaerd (DK)

(21) Appl. No.: 13/825,874

(22) PCT Filed: Oct. 11, 2011
(86) PCT No.: PCT/EP2011/067740

§ 371 Date: Jul. 1, 2013

(30) Foreign Application Priority Data
Oct. 13, 2010 (EP) 10187450.1
Jun. 15, 2011 (EP) 11170033.2

(51) Int. Cl. A21D 2/26; A21D 8/04

(52) U.S. Cl. CPC A21D 2/26; A21D 8/042
USPC 426/20; 426/61; 426/64; 426/63

(57) ABSTRACT

The present invention relates to a method for producing a baked product comprising preparing a dough comprising at least whole meal flour, a GH61 polypeptide, and a cellulase, and baking the dough to form the baked product. The present invention relates also to a baking composition comprising a GH61 polypeptide, a cellulase, and optionally flour. The present invention relates also to the use of a GH61 polypeptide and a cellulase for producing a baked product, e.g. a baked product, prepared from whole meal flour.

### REFERENCE TO A SEQUENCE LISTING

This application contains a Sequence Listing in computer readable form, which is incorporated herein by reference.

### FIELD OF THE INVENTION

The present invention relates to a method for preparing a baked product from whole meal flour. More particularly, it relates to such a method for preparing a baked product with an increased loaf volume.

### BACKGROUND OF THE INVENTION

In the preparation of baked products prepared from whole meal flour it is generally desirable to increase the volume of the baked product.

Whole meal flour is a flour which may be derived by grinding or mashing the whole cereal grain. When used in baking it is typically added to other more refined white flours to provide nutrients (especially fiber and protein), texture, and body to the finished product. The word “whole” refers to the fact that not only the starchy endosperm but also the bran and germ are used in making the flour.

Usually, whole meal flour adds a certain “heaviness” to the dough which prevents it from rising as well as dough from white flours. This adds to the cost per volume of the baked item as it requires more flour to obtain the same volume.

Therefore, there is a need for improved methods for dough and bread making from whole meal flour.

### SUMMARY OF THE INVENTION

The present inventors have now surprisingly discovered that a high-rising, light loaf of whole meal bread can be obtained by adding during the mixing of the dough in addition to the whole meal flour, a cellulase and a GH61 polypeptide.

Accordingly, in a first aspect the invention provides a method for producing a baked product comprising preparing a dough comprising at least whole meal flour, a GH61 polypeptide, and a cellulase, and baking the dough to form the baked product.

In a second aspect the invention provides a method for preparing a baked product comprising adding to a dough ingredients comprising whole meal flour, a cellulase and at least one GH61 polypeptide, and baking the dough to form the baked product, wherein the GH61 polypeptide is present in an amount sufficient to increase the volume of the baked product relative to a similar baked product prepared without a GH61 polypeptide.

In a third aspect the invention provides a baking composition comprising a GH61 polypeptide, a cellulase, and optionally flour.

In a fourth aspect the invention provides a use of a GH61 polypeptide and a cellulase for producing a baked product, e.g. a baked product prepared from whole meal flour.

### DETAILED DESCRIPTION OF THE INVENTION

### The GH61 Polypeptide

The term “GH61 polypeptide” is defined herein as a polypeptide falling into the glycoside hydrolase family 61 according to B. Henrissat, 1991, A classification of glycosyl hydrolases based on amino-acid sequence similarities, Biochem. J. 280: 309-316, and Henrissat B., and Bairoch A., 1996, Updating the sequence-based classification of glycosyl hydrolases, Biochem. J. 316: 695-696. Presently, Henrissat lists the GH61 family as unclassified indicating that properties such as mechanism, catalytic nucleophile/base, catalytic proton donors, and 3-D structure are not known for polypeptides belonging to this family.

A preferred GH61 polypeptide for use in the present invention is the Thermoascus aurantiacus GH61 polypeptide disclosed as amino acids 23-250 of SEQ ID NO:1. Also preferred is a GH61 polypeptide having at least 50%, at least 60%, more preferably at least 65%, more preferably at least 70%, more preferably at least 75%, more preferably at least 80%, more preferably at least 85%, even more preferably at least 90%, most preferably at least 91%, at least 92%, at least 93%, at least 94%, or at least 95%, and even most preferably at least 96%, at least 97%, at least 98%, at least 99%, or at least 100% identity to amino acids 23-250 of SEQ ID NO: 1.

Further preferred for use in the present invention is a GH61 polypeptide having an amino acid sequence that has a degree of identity of preferably at least 50%, at least 60%, more preferably at least 65%, at least 70%, least 75%, at least 80%, at least 85%, even more preferably at least 90%, most preferably at least 91%, at least 92%, at least 93%, at least 94%, or at least 95%, and even most preferably at least 96%, at least 97%, at least 98%, at least 99%, or at least 100% to the mature polypeptide of SEQ ID NO: 2, SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 18, SEQ ID NO: 20, SEQ ID NO: 22, SEQ ID NO: 24, SEQ ID NO: 26, SEQ ID NO: 28, SEQ ID NO: 30, SEQ ID NO: 32, SEQ ID NO: 34, SEQ ID NO: 36, SEQ ID NO: 38, SEQ ID NO: 40, SEQ ID NO: 42, SEQ ID NO: 44, SEQ ID NO: 46, SEQ ID NO: 48, SEQ ID NO: 50, SEQ ID NO: 52, SEQ ID NO: 54, SEQ ID NO: 56, SEQ ID NO: 58, SEQ ID NO: 60, SEQ ID NO: 62, or SEQ ID NO: 64 in U.S. application 61/373,210.

The GH61 polypeptides can be derived or obtained from any suitable origin, including, bacterial, fungal, yeast, plant, or mammalian origin. The term “obtained” means herein that the polypeptide may have been isolated from an organism that naturally produces the polypeptide as a native polypeptide. The term “obtained” also means herein that the polypeptide may have been produced recombinantly in a host organism employing methods described herein, wherein the recombinantly produced polypeptide is either native or foreign to the host organism or has a modified amino acid sequence, e.g., having one or more (several) amino acids that are deleted, inserted and/or substituted, i.e., a recombinantly produced polypeptide that is a mutant and/or a fragment of a native amino acid sequence or an polypeptide produced by nucleic acid shuffling processes known in the art. Encompassed within the meaning of a native polypeptide are natural variants and within the meaning of a foreign polypeptide are variants obtained recombinantly, such as by site-directed mutagenesis or shuffling.

The GH61 polypeptide may be a bacterial polypeptide. For example, the GH61 polypeptide may be a gram positive bacterial polypeptide such as a Bacillus, Streptococcus, Streptomyces, Staphylococcus, Enterococcus, Lactobacillus, Lactococcus, Clostridium, Geobacillus, or Oceanobacillus polypeptide, or a Gram negative bacterial polypeptide such as an E. coli, Pseudomonas, Salmonella, Campylobacter, Helicobacter, Flavobacterium, Fusobacterium, Ilyobacter, Neisseria, or Ureaplasma polypeptide.

In a preferred aspect, the GH61 polypeptide is a Bacillus alkalophilus, Bacillus amyloliquefaciens, Bacillus brevis, Bacillus circulans, Bacillus clausii, Bacillus coagulans, Bacillus firmus, Bacillus lautus, Bacillus lentus, Bacillus licheniformis, Bacillus megaterium, Bacillus pumilus, Bacillus stearothermophilus, Bacillus subtilis, or Bacillus thuringiensis polypeptide.

In another preferred aspect, the GH61 polypeptide is a Streptococcus equisimilis, Streptococcus pyogenes, Streptococcus uberis, or Streptococcus equi subsp. Zooepidemicus polypeptide.

In another preferred aspect, the GH61 polypeptide is a Streptomyces achromogenes, Streptomyces avermitilis, Streptomyces coelicolor, Streptomyces griseus, or Streptomyces lividans polypeptide.

The GH61 polypeptide may also be a fungal polypeptide, and more preferably a yeast polypeptide such as a Candida, Kluyveromyces, Pichia, Saccharomyces, Schizosaccharomyces, or Yarrowia polypeptide; or more preferably a filamentous fungal polypeptide such as an Acremonium, Agaricus, Alternaria, Aspergillus, Aureobasidium, Botryospaeria, Ceriporiopsis, Chaetomidium, Chrysosporium, Claviceps, Cochliobolus, Coprinopsis, Coptotermes, Corynascus, Cryphonectria, Cryptococcus, Diplodia, Exidia, Filibasidium, Fusarium, Gibberella, Holomastigotoides, Humicola, Irpex, Lentinula, Leptospaeria, Magnaporthe, Melanocarpus, Meripilus, Mucor, Myceliophthora, Neocallimastix, Neurospora, Paecilomyces, Penicillium, Phanerochaete, Piromyces, Poitrasia, Pseudoplectania, Pseudotrichonympha, Rhizomucor, Schizophyllum, Scytalidium, Talaromyces, Thermoascus, Thielavia, Tolypocladium, Trichoderma, Trichophaea, Verticillium, Volvariella, or Xylaria polypeptide.

In a preferred aspect, the GH61 polypeptide is a Saccharomyces carlsbergensis, Saccharomyces cerevisiae, Saccharomyces diastaticus, Saccharomyces douglasii, Saccharomyces kluyveri, Saccharomyces norbensis, or Saccharomyces oviformis polypeptide.

In another preferred aspect, the GH61 polypeptide is an Acremonium cellulolyticus, Aspergillus aculeatus, Aspergillus awamori, Aspergillus fumigatus, Aspergillus foetidus, Aspergillus japonicus, Aspergillus nidulans, Aspergillus niger, Aspergillus oryzae, Chrysosporium keratinophilum, Chrysosporium lucknowense, Chrysosporium tropicum, Chrysosporium merdarium, Chrysosporium inops, Chrysosporium pannicola, Chrysosporium queenslandicum, Chrysosporium zonatum, Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, Fusarium sporotrichioides, Fusarium sulphureum, Fusarium torulosum, Fusarium trichothecioides, Fusarium venenatum, Humicola grisea, Humicola insolens, Humicola lanuginosa, Irpex lacteus, Mucor miehei, Myceliophthora thermophila, Neurospora crassa, Penicillium funiculosum, Penicillium purpurogenum, Phanerochaete chrysosporium, Thielavia achromatica, Thielavia albomyces, Thielavia albopilosa, Thielavia australeinsis, Thielavia fimeti, Thielavia microspora, Thielavia ovispora, Thielavia peruviana, Thielavia spededonium, Thielavia setosa, Thielavia subthermophila, Thielavia terrestris, Trichoderma harzianum, Trichoderma koningii, Trichoderma longibrachiatum, Trichoderma reesei, Trichoderma viride, or Trichophaea saccata polypeptide.

### The Cellulase

The cellulase is preferably a cellulase preparation comprises one or more enzyme activities selected from the group consisting of beta-glucanase, cellulase, cellobiohydrolase, and beta-glucosidase.

In an embodiment the cellulase preparation is a complex of cellulases and/or hemicellulases, preferably obtained from Trichoderma sp., more preferably from T. reesei. Also preferred are cellulase preparations obtained from Aspergillus, preferably obtained from A. niger.

A suitable cellulase composition may be CELLUCLAST™ (available from Novozymes) or Bakezyme® XU, Bakezyme® XE, BakeZyme® X-cell or Bakezyme® W (all available from DSM).

### The Additional Enzymes

Optionally, additional enzymes, e.g., glucoamylase, alpha-amylase, xylanase, protease, lipase, phospholipase may be used together with the GH61 polypeptide in the dough or the composition. The additional enzyme may be of any origin, including mammalian and plant, and preferably of microbial (bacterial, yeast or fungal) origin.

The glucoamylase for use in the present invention also include glucoamylases having a sequence identity of at least 50%, at least 60%, at least 65%, at least 70%, at least 75%, at least 80%, at least 85%, at least 90%, at least 95%, at least 96%, at least 97%, at least 98%, or at least 99% to the amino acid sequence of the A. niger G1 or G2 glucoamylase (Boel et al. (1984), EMBO J. 3 (5), p. 1097-1102), the A. awamori glucoamylase disclosed in WO 84/02921, or the A. oryzae glucoamylase (Agric. Biol. Chem. (1991), 55 (4), p. 941-949).

The amylase may be fungal or bacterial, e.g. a maltogenic alpha-amylase from B. stearothermophilus or an alpha-amylase from Bacillus, e.g. B. licheniformis or B. amyloliquefaciens, a beta-amylase, e.g. from plant (e.g. soy bean) or from microbial sources (e.g. Bacillus), a glucoamylase, e.g. from A. niger, or a fungal alpha-amylase, e.g. from A. oryzae.

Suitable commercial maltogenic alpha-amylases include NOVAMYL® (Novozymes A/S) and OPTICAKE® (Novozymes A/S). Suitable commercial fungal alpha-amylase compositions include, e.g., BAKEZYME P 300 (available from DSM) and FUNGAMYL 2500 SG, FUNGAMYL 4000 BG, FUNGAMYL 800 L, FUNGAMYL ULTRA BG and FUNGAMYL ULTRA SG (available from Novozymes A/S)

The hemicellulase may be a pentosanase, e.g. a xylanase which may be of microbial origin, e.g. derived from a bacterium or fungus, such as a strain of Aspergillus, in particular of A. aculeatus, A. niger, A. awamori, or A. tubigensis, from a strain of Trichoderma, e.g. T. reesei, or from a strain of Humicola, e.g. H. insolens.

Suitable commercially available xylanase preparations for use in the present invention include PENTOPAN MONO BG and PENTOPAN 500 BG (available from Novozymes), GRINDAMYL POWERBAKE (available from Danisco), and BAKEZYME BXP 5000 and BAKEZYME BXP 5001 (available from DSM).

The protease may be from Bacillus, e.g. B. amyloliquefaciens.

The lipase may be derived from a strain of Thermomyces (Humicola), Rhizomucor, Candida, Aspergillus, Rhizopus, or Pseudomonas, in particular from T. lanuginosus (H. lanuginosa), Rhizomucor miehei, C. antarctica, A. niger, Rhizopus delemar, Rhizopus arrhizus or P. cepacia.

The phospholipase may have phospholipase A1, A2, B, C, D or lysophospholipase activity; it may or may not have lipase activity. It may be of animal origin, e.g. from pancreas, snake venom or bee venom, or it may be of microbial origin, e.g. from filamentous fungi, yeast or bacteria, such as Aspergillus or Fusarium, e.g. A. niger, A. oryzae or F. oxysporum. A preferred lipase/phospholipase from Fusarium oxysporum is disclosed in WO 98/26057. Also, the variants described in WO 00/32758 may be used.

The additional enzyme may be of any origin, including mammalian and plant, and preferably of microbial (bacterial, yeast or fungal) origin and may be obtained by techniques conventionally used in the art.

Suitable phospholipase compositions are LIPOPAN F and LIPOPAN XTRA (available from Novozymes) or PANAMORE GOLDEN and PANAMORE SPRING (available from DSM).

### Compositions Comprising a GH61 Polypeptide

In a still further aspect, the present invention relates to compositions comprising a cellulase and a GH61 polypeptide and their preparation, e.g. compositions suitable for increasing the loaf volume of a baked product, in particular of a baked product prepared from a dough comprising whole meal flour. The composition may be a dough improver and/or a baking premix.

The composition may further comprise one or more enzymes, in particular carbohydrases such as amylase, glucanase, galactanase, mannanase etc, The enzymes may also include enzymes such as aminopeptidase, alpha-amylase, beta-amylase, carboxypeptidase, catalase, chitinase, cutinase, cyclodextrin glycosyltransferase, deoxyribonuclease, esterase, alpha-galactosidase, beta-galactosidase, glucoamylase, alpha-glucosidase, beta-glucosidase, haloperoxidase, invertase, laccase, lipase, phospholipase, mannosidase, oxidase, pectinolytic enzymes, peptidoglutaminase, peroxidase, phytase, polyphenoloxidase, proteolytic enzyme, ribonuclease, or transglutaminase. In a particular embodiment the alpha-amylase is a maltogenic alpha-amylase.

The compositions may be prepared in accordance with methods known in the art and may have any physical appearance such as liquid, paste or solid. For instance, the composition may be formulated using methods known to the art of formulating enzymes and/or pharmaceutical products, e.g. into coated or uncoated granules or micro-granules. The GH61 polypeptide, cellulase, or additional enzymes to be included in the composition may be stabilized in accordance with methods known in the art e.g. by stabilizing the polypeptide in the composition by adding and antioxidant or reducing agent to limit oxidation or the polypeptide of it may be stabilized by adding polymers such as PVP, PVA, PEG or other suitable polymers known to be beneficial to the stability of polypeptides in solid or liquid compositions. When formulating a cellulase and a GH-61 polypeptide as a granulate or agglomerated powder the particles particularly have a narrow particle size distribution with more than 95% (by weight) of the particles in the range from 25 to 500 p.m. Granulates and agglomerated powders may be prepared by conventional methods, e.g. by spraying a cellulase and a GH-61 polypeptide onto a carrier in a fluid-bed granulator. The carrier may consist of particulate cores having a suitable particle size. The carrier may be soluble or insoluble, e.g. a salt (such as NaCl or sodium sulfate), a sugar (such as sucrose or lactose), a sugar alcohol (such as sorbitol), starch, rice, corn grits, or soy. Hence the invention also provides a granule comprising a cellulase and a GH-61 polypeptide.

In a particular embodiment the composition is a dough composition or a dough improving additive or a premix comprising a cellulase and a GH-61 polypeptide.

The composition is preferably in the form of a dry powder or a granulate, in particular a non-dusting granulate, or in the form of a liquid, preferably with one or more stabilizer(s) such as polyols, sugars, organic acids or sugar alcohols.

The amount of GH-61 polypeptide in the composition may be between 0.5-1000 mg polypeptide per kg dry matter, 0.5-100 mg polypeptide per kg dry matter, 0.5-50 mg polypeptide per kg dry matter, 1-25 mg polypeptide per kg dry matter, 1-15 mg polypeptide per kg dry matter, 2-10 mg/kg. Preferably the composition comprises GH-61 polypeptide in an amount of at least 0.5 mg polypeptide per kg dry matter, at least 1 mg polypeptide per kg dry matter, at least 10 mg polypeptide per kg dry matter, at least 50 mg polypeptide per kg dry matter, at least 100 mg polypeptide per kg dry matter, at least 500 mg polypeptide per kg dry matter, or even at least 1000 mg polypeptide per kg dry matter.

The amount of cellulase in the composition may be between 0.5-1000 mg polypeptide per kg dry matter, 0.5-100 mg polypeptide per kg dry matter, 0.5-50 mg polypeptide per kg dry matter, 1-25 mg polypeptide per kg dry matter, 1-15 mg polypeptide per kg dry matter, 2-10 mg/kg. Preferably the composition comprises cellulase in an amount of at least 0.5 mg polypeptide per kg dry matter, at least 1 mg polypeptide per kg dry matter, at least 10 mg polypeptide per kg dry matter, at least 50 mg polypeptide per kg dry matter, at least 100 mg polypeptide per kg dry matter, at least 500 mg polypeptide per kg dry matter, at least 1000 mg polypeptide per kg dry matter, or even at least 5000 mg polypeptide per kg dry matter.

### Dough

The dough of the invention preferably comprises whole meal flour. Whole meal flour may be derived from grinding of cereal grains and is defined as flour comprising the components of the starchy endosperm, germ and bran in substantially the same relative proportions as they exist in the intact cereal grains. The production of whole meal flour may include temporary separation of the grains constituents for later recombination.

Preferably the dough comprises at least 90%, at least 80%, at least 70%, at least 60%, at least 50%, at least 40%, at least 30% percent whole meal flour as determined in % of total amount of flour. Accordingly, a whole meal bread comprises at least 90%, at least 80%, at least 70%, at least 60%, at least 50%, at least 40%, at least 30% percent whole meal flour as determined in % of total amount of flour.

The whole meal flour may be derived from any cereal grain, including wheat, barley, rye, oat, corn, sorghum, rice and millet. In a preferred embodiment the whole meal flour is derived from wheat. In such a preferred embodiment the dough comprises at least 90%, at least 80%, at least 70%, at least 60%, at least 50%, at least 40%, at least 30% percent whole wheat flour as determined in % of total amount of flour. Accordingly, a whole wheat bread is a bread that comprises at least 90%, at least 80%, at least 70%, at least 60%, at least 50%, at least 40%, at least 30% percent whole meal flour as determined in % of total amount of flour.

In addition the dough may comprise types of refined flour or starch such as wheat flour, corn flour, corn starch, rye flour, oat flour, soy flour, sorghum flour, potato meal, potato flour or potato starch.

The dough of the invention may be fresh, frozen or par-baked.

The dough of the invention is normally a leavened dough or a dough to be subjected to leavening. The dough may be leavened in various ways, such as by adding chemical leavening agents, e.g., sodium bicarbonate or by adding a leaven (fermenting dough), but it is preferred to leaven the dough by adding a suitable yeast culture, such as a culture of Saccharomyces cerevisiae (baker's yeast), e.g. a commercially available strain of S. cerevisiae.

The dough may also comprise other conventional dough ingredients, e.g.: proteins, such as milk powder, gluten, and soy; eggs (either whole eggs, egg yolks or egg whites); an oxidant such as ascorbic acid, potassium bromate, potassium iodate, azodicarbonamide (ADA) or ammonium persulfate; an amino acid such as L-cysteine; a sugar; a salt such as sodium chloride, calcium acetate, sodium sulfate or calcium sulfate.

The dough may comprise fat (triglyceride) such as granulated fat or shortening, but the invention is equally applicable to a dough where less than 1% by weight of fat (triglyceride) is added, and particularly to a dough which is made without addition of fat.

The dough may further comprise an emulsifier such as mono- or diglycerides, diacetyl tartaric acid esters of mono- or diglycerides, sugar esters of fatty acids, polyglycerol esters of fatty acids, lactic acid esters of monoglycerides, acetic acid esters of monoglycerides, polyoxyethylene stearates, or lysolecithin.

The amount of GH-61 polypeptide in the dough may be between 0.5-100 mg polypeptide per kg dry matter in the dough, in particular 0.5-50 mg polypeptide per kg dry matter, in particular 1-25 mg polypeptide per kg dry matter, in particular 1-15 mg polypeptide per kg dry matter in the dough, in particular 2-10 mg/kg.

The amount of GH-61 polypeptide in the dough may be between 0.5-100 mg polypeptide per kg dry matter in the dough, in particular 0.5-50 mg polypeptide per kg dry matter, 1-25 mg polypeptide per kg dry matter, 1-15 mg polypeptide per kg dry matter in the dough, 2-10 mg/kg, in particular 2-50 mg/kg.

### Degree of Sequence Identity

For purposes of the present invention, the degree of sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 3.0.0 or later. The optional parameters used are gap open penalty of 10, gap extension penalty of 0.5, and the EBLOSUM62 (EMBOSS version of BLOSUM62) substitution matrix. The output of Needle labeled “longest identity” (obtained using the—nobrief option) is used as the percent identity and is calculated as follows:

(Identical Residues×100)/(Length of Alignment−Total Number of Gaps in Alignment)

### EXAMPLES

### Example 1

### Effect of GH61 Polypeptide and Cellulase on Volume in Whole Wheat Bread

The GH61 polypeptide was from Thermoascus aurantiacus SEQ ID NO:1 herein (SEQ ID NO:2 in WO 2005/074656). The cellulase preparation was derived from Trichoderma reesei and in the form of the commercial product Celluclast™ BG available from Novozymes.

Whole wheat bread was prepared according to the sponge-and-dough procedure. First a sponge was prepared by mixing 37.3 parts of water, 57.4 parts of whole wheat flour, 4.8 parts of compressed yeast and 0.5 part of SSL (sodium stearoyl-2-lactylate).

The sponge was fermented for 2 hours at 27° C. and 86% relative humidity. Subsequently, a dough was prepared by mixing the sponge with 37 parts of water, 37.42 parts of whole wheat flour, 9.35 parts of wheat gluten, 7.48 parts of glucose syrup (containing 29% water), 3.74 parts of cane syrup, 1.87 parts of salt, 1.87 parts of soy oil, 0.94 part of monoglycerides, 0.23 part of calcium propionate, 0.06 part of ascorbic acid and 0.04 part of ADA (azodicarbonamide).

Enzymes were added to the dough according to the table below and the dough was fermented for 45 minutes at 42° C. and 86% relative humidity and afterwards baked for 25 minutes at 225° C.

The volume of each loaf was measured by the rapeseed displacement method (AACC Method 10-05.01) and is expressed as specific volume (ml/g) (mean of triplicates). The addition of GH61 together with a cellulase preparation resulted in volume increase.

TABLE 1
Specific volume (ml/g) of bread prepared with cellulase or with
cellulase + GH61 polypeptide (dosed per kg flour).

| | Mean | Standard deviation |
|---|---|---|
| No enzyme added | 4.15 | 0.10 |
| 50 ppm Celluclast | 4.29 | 0.03 |
| 50 ppm Celluclast + 2 mg GH61 polypeptide | 4.49 | 0.06 |

1-15. (canceled)

16. A method for producing a baked product comprising preparing a dough comprising at least whole meal flour, a GH61 polypeptide, and a cellulase, and baking the dough to form the baked product.

17. A method for preparing a baked product comprising adding to a dough ingredients comprising whole meal flour, a cellulase and at least one GH61 polypeptide, and baking the dough to form the baked product, wherein the GH61 polypeptide is present in an amount sufficient to increase volume of the baked product relative to a similar baked product prepared without a GH61 polypeptide.

18. The method of claim 16, wherein the whole meal flour comprises whole wheat flour.

19. The method of claim 16, wherein said GH61 polypeptide has an identity of at least 80% with amino acids 23-250 of SEQ ID NO:1.

20. The method of claim 16, wherein said GH61 polypeptide has an identity of at least 90% with amino acids 23-250 of SEQ ID NO:1.

21. The method of claim 16, wherein said GH61 polypeptide has an identity of at least 95% with amino acids 23-250 of SEQ ID NO:1.

22. The method of claim 16, wherein the cellulase is derived from T. reesei.

23. The method of claim 16, wherein the GH61 polypeptide is added in the form of a dry powder or a granulate.

24. The method of claim 16, wherein the GH61 polypeptide is added in the form of a liquid.

25. A baking composition comprising a GH61 polypeptide, a cellulase, and optionally flour.

26. The baking composition of claim 25, which is a dough, a flour composition, a bread improver or a flour premix.

27. The baking composition of claim 25, which is in the form of a dry powder or a granulate.

28. The baking composition of claim 25, which is in the form of a liquid.

29. The baking composition of claim 25, comprising one or more selected from wheat flour, corn flour, corn starch, rye flour, oat flour, soy flour, sorghum flour, potato meal, potato flour and potato starch, or a combination thereof.

30. The baking composition of claim 25, further comprising an additional enzyme, selected from the group consisting of aminopeptidase, alpha-amylase, beta-amylase, maltogenic alpha-amylase, carboxypeptidase, catalase, chitinase, cutinase, cyclodextrin glycosyltransferase, deoxyribonuclease, esterase, alpha-galactosidase, beta-galactosidase, glucoamylase, alpha-glucosidase, beta-glucosidase, haloperoxidase, invertase, laccase, lipase, phospholipase, mannosidase, oxidase, pectinolytic enzymes, peptidoglutaminase, peroxidase, phytase, polyphenoloxidase, proteolytic enzyme, ribonuclease, or transglutaminase, or a combination thereof.

31. The baking composition of claim 25, wherein said GH61 polypeptide has an identity of at least 80% with amino acids 23-250 of SEQ ID NO:1.

32. The baking composition of claim 25, wherein said GH61 polypeptide has an identity of at least 90% with amino acids 23-250 of SEQ ID NO:1.

33. The baking composition of claim 25, wherein said GH61 polypeptide has an identity of at least 95% with amino acids 23-250 of SEQ ID NO:1.

34. The baking composition of claim 25, wherein said GH61 polypeptide is present in an amount of at least 0.5 mg polypeptide per kg dry matter.

35. The baking composition of claim 25, wherein said GH61 polypeptide is present in an amount of at least 1 mg polypeptide per kg dry matter.


SEQUENCE LISTING (1 sequence)

SEQ ID NO: 1 - protein, 250 aa, Thermoascus aurantiacus
MSFSKIIATAGVLASASLVAGHGFVQNIVIDGKKYYGGYLVNQYPYMSNPPEVIAWSTTATDLGFVDGTGYQTPDIICHRGAKPGALTAPVSPGGTVELQWTPWPDSHHGPVINYLAPCNGDCSTVDKTQLEFFKIAESGLINDDNPPGIWASDNLIAANNSWTVTIPTTIAPGNYVLRHEIIALHSAQNQDGAQNYPQCINLQVTGGGSDNPAGTLGTALYHDTDPGILINIYQKLSSYIIPGPPLYTG